(19) United States
(12) Patent Application Publication
(10) Pub. No.: US 2025/0196268 A1
(43) Pub. Date: Jun. 19, 2025

(54) METHOD FOR PRODUCING DIMPLES ON THE SURFACE OF A TRANSPARENT MATERIAL

(71) Applicant: TRUMPF LASER GMBH, Schramberg (DE)

(72) Inventors: Jonas Kleiner, Leonberg (DE); Felix Zimmermann, Ditzingen (DE); Max Kahmann, Nufringen (DE); Daniel Flamm, Ludwigsburg (DE); Myriam Kaiser, Heimsheim (DE); Daniel Großmann, Schramberg (DE)

(21) Appl. No.: 19/073,054

(22) Filed: Mar. 7, 2025

Related U.S. Application Data
(63) Continuation of application No. PCT/EP2023/073718, filed on Aug. 29, 2023.

(30) Foreign Application Priority Data
Sep. 9, 2022 (DE) 10 2022 122 965.3

(51) Int. Cl. B23K 26/352; B23K 26/0622

(52) U.S. Cl. CPC B23K 26/355; B23K 26/0624

(57) ABSTRACT

A method for producing dimples on a surface of a transparent material using laser pulses of a short-pulse laser is provided. The method includes producing at least one dimple of the dimples on the surface of the transparent material by using a single laser pulse or a single laser burst.

### CROSS REFERENCE TO RELATED APPLICATIONS

This application is a continuation of International Application No. PCT/EP2023/073718 (WO 2024/052177 A1), filed on Aug. 29, 2023, and claims benefit to German Patent Application No. DE 10 2022 122 965.3, filed on Sep. 9, 2022. The aforementioned applications are hereby incorporated by reference herein.

### FIELD

Embodiments of the present invention relate to the production of dimples on the surface of a transparent material.

### BACKGROUND

It is known that material can be removed from a component during laser machining by vaporizing the material within the focus zone of a laser beam through a strong light-matter interaction. The resulting structural depressions are called dimples.

It is further known that, by means of a successive interaction of the same material region with at least two laser pulses, so-called laser-induced periodic surface structures (LIPSS) can also be produced.

In this regard, dimples and LIPSS are suitable for the functionalization of component surfaces, wherein visual properties, wetting properties and tribological properties can, in particular, be influenced.

From DE 10 2017 006 358 A1, a method for producing a structured surface on a substrate is known, in which surface structures are produced with dimensions in the sub-micrometer range by treatment with an intensive pulsed laser beam.

From EP 3 270 016 B1, a method for machining a sliding component is known, wherein the sliding component has a pair of sliding parts and the sliding component has a plurality of recesses which are formed by irradiation with an ultrashort pulse laser produced by an ultrashort pulse laser oscillator.

From US 2018/0118612 A1, a method is known for making a glass surface oleophobic/hydrophobic. The process involves exposing the glass surface to a femtosecond UV excimer laser to vaporize parts of the glass surface and to form nanostructures in the glass surface without significantly reducing the optical clarity of the glass surface.

### SUMMARY

Embodiments of the present invention provide a method for producing dimples on a surface of a transparent material using laser pulses of a short-pulse laser. The method includes producing at least one dimple by using a single laser pulse or a single laser burst.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic structure for producing dimples according to some embodiments;

FIG. 2A, FIG. 2B, FIG. 2C and FIG. 2D show a schematic representation of a multi-focus distribution according to some embodiments;

FIG. 3 shows a microscopic image of a transparent material with a random arrangement of dimples according to some embodiments; and

FIG. 4 shows a confocal microscope image of a transparent material with a random arrangement of dimples according to some embodiments.

### DETAILED DESCRIPTION

Embodiments of the present invention provide an improved method.

According to some embodiments, the production of dimples on the surface of a transparent material using laser pulses of a short-pulse laser is provided, wherein at least one dimple is produced by means of a single laser pulse or a single laser burst.

The transparent material of the component can be a material such as a polymer or a plastic. The material to be processed can also be a semiconductor, for example an elemental semiconductor such as silicon or germanium, or a III-V semiconductor such as gallium arsenide, or an organic semiconductor or any other type of semiconductor. By way of example, the material can be a silicon wafer. In particular, the material can be a layer system, wherein each layer may be chosen from the group of metals, polymers, plastics or semiconductors. In particular, the material can also be glass, for example sapphire or quartz glass.

“Transparent” can mean that the material is optically transparent, i.e., transparent to the wavelengths visible to the human eye. For example, the material may transmit visible light more than 80% or more than 85% or more than 90% or more than 95% or more than 99%. However, “transparent” can also mean that the material is transparent to the wavelength of a processing laser.

The short pulse laser provides the laser pulses of the laser beam, wherein the individual laser pulses form the laser beam in the beam propagation direction.

The pulse duration of the laser pulses can be between 300 fs and 10 ps or between 100 ps and 100 ns.

In the range between 300 fs and 10 ps, LIPSS can be produced particularly easily, while the pulse duration between 100 ps and 100 ns is particularly suitable for producing dimples using a UV laser.

The wavelength of the laser pulses can be between 300 nm and 3000 nm, preferably between 900 nm and 2200 nm.

This allows a laser wavelength to be selected, at which the material is transparent, so that the dimples and the LIPSS can be introduced into the material via a nonlinear interaction. In addition, the short pulse duration can prevent unwanted heating of the material, which counteracts the formation of LIPSS.

Instead of individual laser pulses, the laser can also provide laser bursts, wherein each burst comprises the emission of multiple laser pulses. In this regard, the laser pulses can be emitted very shortly after one another, spaced apart by a few picoseconds to nanoseconds, for a specific time interval. In particular, the laser bursts can be GHz bursts, in which the sequence of successive laser pulses of the respective burst occurs in the GHz range.

For example, a burst can contain between 2 and 10 laser pulses, wherein the time interval between the laser pulses can be between 10 ns and 50 ns.

However, a burst can also contain between 30 and 300 laser pulses, wherein the time interval between the laser pulses can be between 100 ps and 1000 ps.

For example, the length of the laser pulses can be between 100 ps and 100 ns, in particular between Ins and 20 ns, wherein the wavelength can be between 300 nm and 550 nm, in particular 355 nm, wherein the repetition frequency of the laser pulses can be between 10 kHz and 100 kHz, in particular between 10 kHz and 50 kHz, wherein the laser pulses can have an energy between 60 μJ and 300 μJ and 1 to 4 pulses can be emitted per spot.

For example, the length of the laser pulses can be between 200 fs and 1000 fs, in particular between 300 fs and 450 fs, wherein the wavelength can be between 900 nm and 2300 nm, in particular 1030 nm, wherein the repetition frequency of the laser pulses can be between 10 kHz and 400 kHz, wherein the laser pulses are emitted in laser bursts, wherein each laser burst can contain between 2 and 4 laser pulses, wherein the laser bursts can have an energy between 100 μJ and 400 μJ and the numerical aperture can be between 0.01 and 0.2, in particular 0.08.

In particular, the laser pulses of a laser burst act together on the material due to the rapid pulse sequence.

The laser pulses are introduced into the material, wherein the energy of the laser beam is at least partially absorbed in the material, for example by nonlinear interactions, in particular by multiphoton processes.

Here, the focus of the laser beam can be located in the beam propagation direction above the surface of the material to be processed or under the surface in the volume of the material to be processed. The focus position can also be located precisely on the surface of the material to be processed. In particular, the focus position can be within ten times the Rayleigh length from the surface, wherein the Rayleigh length is the distance along the optical axis that a laser beam needs until its cross-sectional area doubles, starting from the beam waistor the focus.

In particular, the term “focus” can generally be understood as a targeted increase in intensity, wherein the laser energy converges in a “focal range”. In particular, the term “focus” is therefore used below irrespective of the actual beam shape used and the methods used to bring about an increase in intensity. The location of the increase in intensity along the beam propagation direction can also be influenced by “focusing”. For example, the increase in intensity can be virtually punctiform and the focal range can have a Gaussian intensity cross-section, as is provided by a Gaussian laser beam. The increase in intensity can also be linear, wherein a Bessel-type focal range is created around the focus position, as can be provided by a non-diffracting beam. Furthermore, other more complex beam shapes are also possible, the focus position of which extends in three dimensions, for example a multi-spot profile of Gaussian laser beams and/or non-Gaussian intensity distributions.

As a result of the energy absorbed from the laser beam, the material heats up in accordance with the intensity distribution of the laser and/or transitions into a temporary plasma state on account of the electromagnetic interaction between the laser and the material. In particular, in addition to linear absorption processes, non-linear absorption processes can also be used, which become accessible through the use of high laser energies or laser intensities. Accordingly, the material is modified particularly in the focus of the laser, as this is where the intensity of the laser beam is greatest. What this can achieve, in particular, is that a part of the material can be detached from the material compound, the material for example melting or being evaporated. Hence, processing processes known per se are possible in relation to the interaction between the laser light and the material to be processed, these methods being known as laser drilling, percussion drilling or laser ablation, for example.

The interaction of a single laser pulse or a single laser burst with the material to be processed produces at least one dimple on the surface of the transparent material.

A dimple is produced by the vaporization of material on the surface by the irradiated laser intensity. The material is vaporized in particular where the intensity of the laser beam exceeds a critical, material-specific processing threshold. Accordingly, the shape and form of the laser beam, in particular the beam profile, is crucial to the shape and form of the dimples.

In the simplest case, the laser beam is a Gaussian laser beam with a Gaussian beam profile. There is a certain spatial area around the focal point in which the laser energy is above the critical threshold. In other words, there is an isointensity area in the intensity distribution of the laser beam in the focus, within which the material can be vaporized. The shape and form of the dimple results from this isointensity area.

In particular, dimples can therefore have a round, elliptical or angular, in particular square, or angular-rounded cross-section in the plane of the material surface, wherein the dimples have an increasing depth from the edge to the center. In particular, the cross-section of the dimples in the plane perpendicular to the surface can also be round or rounded.

By introducing dimples onto the surface of the material, the optical properties of the material can for example be determined, for example by scattering light guided through a transparent material at the dimples, thus making the material appear diffuse and/or matt. In particular, dimples on the surface of the material can suppress the reflection on the material.

For example, the at least two laser pulses of a laser burst can spatially overlap, thereby producing so-called LIPSS. This happens when an excited plasmonic state is present in the first dimple, with which a second laser pulse of the laser burst can interact, so that the heated material orients itself along the electric field of the second laser pulse.

The combination of dimples and LIPSS can be used for complex functionalization of the surface of the transparent material.

For example, the feel or roughness can be adjusted by the type and shape of the dimples, as well as the distribution of the dimples on the surface of the material. However, it is also possible to adjust the scattering of light and thus the optical properties of the material.

The size of the LIPSS, however, can be used to further functionalize the surface, for example. For example, LIPSS can be used to adjust the wetting properties of a surface because LIPSS change the contact angle between a liquid and the material. In addition, the tribological properties of the material can also be changed and, for example, the sliding properties of the material can be adjusted.

The combination of dimples and LIPSS allows the surface of the transparent material to be optically and mechanically functionalized.

In particular, the dimples and LIPSS can be produced particularly efficiently by the present method.

In addition, the laser can have a linear polarization, for example the degree of polarization of the laser beam can be more than 80%, preferably more than 95%.

Due to the high linear polarization, LIPSS can be produced particularly easily in the dimples.

However, it is also possible that the laser beam is circularly or elliptically polarized and only dimples are produced.

The average emitted laser power at the laser output can be between 30 W and 1000 W, preferably between 30 W and 300 W.

Due to the high average power, it is possible, for example, to form a plurality of partial laser beams from a single laser beam, wherein each partial laser beam can produce its own dimple. In particular, this makes it possible to work at a high feed rate, so that the energy of the laser beam can be distributed over a large area.

The specified power range also corresponds to a commercially available short-pulse laser, so that the costs of the procedure can be kept low.

In a preferred embodiment of the method, the laser pulse duration is between 300 fs and 10 ps at a wavelength between 900 nm and 1200 nm or between 100 ps and 100 ns at a wavelength between 300 nm and 520 nm, wherein the at least one dimple is produced by means of a laser burst, wherein the laser burst comprises between 2 and 10 laser pulses and the time interval between the laser pulses is between 10 ns and 50 ns, wherein the degree of polarization of the laser is preferably more than 80% and wherein the average emitted laser power at the laser outlet is preferably between 30 W and 1000 W.

In a further preferred embodiment of the method, the laser pulse duration is between 300 fs and 10 ps or between 100 ps and 100 ns, wherein the at least one dimple is produced by means of a laser burst, wherein the laser burst comprises between 30 and 300 laser pulses and the time interval between the laser pulses is between 100 ps and 1000 ps, wherein the degree of polarization of the laser is preferably more than 80% and wherein the average emitted laser power at the laser outlet is preferably between 30 W and 1000 W.

In a particularly preferred embodiment of the method, the laser pulse duration is between 300 fs and 10 ps, wherein the at least one dimple is produced by means of a laser burst and the laser burst comprises between 2 and 10 laser pulses, wherein the time interval of the laser pulses is between 10 ns and 50 ns and the degree of polarization of the laser is more than 95% and the average emitted laser power at the laser outlet is between 30 W and 300 W.

The photon energy of the laser pulses or laser bursts is smaller than the band gap of the material.

The band gap is the energetic distance between the valence band and the power band of the material, wherein the electrical and optical properties are substantially determined by the size of the band gap.

If the photon energy of the laser is smaller than the band gap, then the photon cannot be absorbed by the solid, so the material appears transparent to the wavelength of the laser.

For example, the band gap in quartz glass can be about 9 eV, so that optical absorption is only possible at photon energies of more than 9 eV. The band gap corresponds to a wavelength of about 137 nm, so that quartz glass is transparent to photons of lower energy, i.e., longer wavelength.

The dimples can have a depth between 100 nm and 2000 nm, preferably between 200 nm and 1000 nm.

This makes it particularly advantageous to adjust the roughness of the surface, wherein extensive weakening of the material can be avoided.

The dimples can have a diameter between 3 μm and 30 μm, preferably between 3 μm and 10 μm.

This allows the diameter to be adjusted particularly advantageously to the microstructure required for functionalization.

The dimples can vary in size from a diameter of 5% to 80%.

For example, the size variation can be 50% and the diameter of the dimples can be 20 μm. Then the dimples on the surface can have diameters between 10 μm and 30 μm

The LIPSS can have a periodicity between 40 nm and 1000 nm, preferably between 50 nm and 300 nm.

The periodicity is determined by the distance between two neighboring peaks or valleys in the profile of a LIPSS. The periodicity makes it particularly advantageous to adjust the functionalization of the surface. For example, a LIPSS can have a periodicity of 100 nm for the medical field, so that the surface appears particularly hygrophilic. This means that a surface treated in this way can be used particularly advantageously in endoscopes or laryngoscopes, for example, so that the appropriately treated surfaces have a liquid-repellent effect and therefore allow a clear view of the inside of the body when used in the body, for example. In particular, such a functionalized surface is particularly suitable for use in medical devices that enable optical access to the interior of the body.

In a particularly preferred embodiment, the dimples have a diameter between 13 μm and 20 μm, wherein the laser-induced periodic surface structures have a periodicity of between 650 nm and 1000 nm.

The roughness of the transparent component can be between 0.05 μm and 1.5 μm.

This can create a particularly high-quality haptic impression of the surface.

The surface roughness can be defined as a peak-to-valley value, i.e., the distance from the highest elevation to the lowest depression. However, it may also be that the roughness is defined as the standard deviation of the depth of the dimples.

The area filling of the surface with dimples can be between 20% and 95%.

The area filling of the surface is given by the area ratio of the processed surface by the dimples and the total surface of the transparent material. Depending on the desired roughness or functionalization, the area filling can be adjusted.

In particular, when machining the surface, the dimples can also be introduced successively or in several passes, wherein the area coverage is successively increased, while distortion or smearing of the dimples is reduced.

In particular, at least two dimples can spatially overlap.

“Spatially overlap” can mean that the dimples touch at the edge, or that the dimples partially lie on top of each other, i.e., that a surface intersection of the dimples exists.

The LIPSS can cover the dimples by less than 90%.

For example, the LIPSS can be centered in the dimple. For example, a dimple can have a diameter of 10 μm, whereas the LIPSS are only found in a surface area with a diameter of 9 μm.

However, it is also possible that two dimples overlap and LIPSS is formed only in the spatial overlap.

The laser beam and the material can be displaced relative to one another by a feed device.

“Displaceable relative to one another” means that both the laser beam can be displaced in translation relative to a stationary material and the material can be displaced relative to the laser beam, or both the material and the laser beam can be moved.

In particular, this allows the focus of the laser beam to be placed at different locations on the material in order to introduce laser pulses. For example, the laser points can be randomly distributed into the material around a feed trajectory, wherein the feed trajectory can be straight or curved. This, for example, allows the laser beam to be moved along with a feed while the laser pulses are emitted into or onto the material.

The feed device can preferably comprise an axis device and/or a scanner device.

For example, the axis device can be used to move the material mechanically, while a scanner device is used to move the laser beam over the material. In particular, the axis device can be an XYZ table with a stepping motor control. However, it is also possible that the axis device is designed with piezo adjustments in order to achieve the fastest possible adjustment. In particular, the scanner device can be a galvo scanner.

The laser beam can be focused onto the surface of the material using processing optics.

The processing optics can in particular be a lens or an objective or a telescope. In particular, the processing optics can be arranged behind the optional beam shaping device in the beam propagation direction and in front of the surface of the transparent material.

The dimples can be randomly arranged on the surface of the transparent material.

A random arrangement can occur if the spatial distances between the dimples have a random size. The spatial distances result from the center distances or the minimum distances from dimple edge to dimple edge.

In particular, for example, the spatial distribution of the dimples, including the size of the dimples, results in a spatial frequency distribution of the dimples via a Fourier transformation. The more irregular the distances between the dimples are, the larger the bandwidth of the spatial frequency distribution and the more diffusely an incident light beam is reflected by the transparent material.

In particular, “randomly arranged” can mean that the dimples are randomly distributed in the spatial frequency space. By displaying the position of the dimples in the spatial frequency domain, it is also possible to identify potential spatial directions along which interference of the reflected or transmitted light could occur in order to optimize the arrangement.

“Randomly distributed” can also mean that the spatial distribution of the dimples follows a random distribution, for example a uniform distribution, a Gaussian distribution, a triangular distribution, or another statistical distribution of the dimples on the surface of the transparent material.

The laser beam can be is shaped into a multi-focus distribution by means of a beam shaping device and the surface can be exposed to the multi-focus distribution and thus several dimples can be produced using a single laser pulse or a single laser burst.

The multi-focus distribution is a spatial distribution of individual focus zones, so-called single foci. The multi-focus distribution comprises at least two individual foci, whereby the individual foci are spatially separated from each other. However, the individual foci can all lie in one focal plane, so that the individual foci are all found in one plane along the beam propagation direction of the laser beam, but have different coordinates on the surface of the transparent material.

A multi-focus distribution can be provided by a beam shaping device, whereby the incident laser beam can be converted into a plurality of partial laser beams which are guided to different individual foci. Beam shaping includes the design of the multi-focus distribution. However, beam shaping can also include the design of individual foci, such as the formation of Gaussian or non-diffracting laser beams.

For example, a laser can emit an energy of 10 mJ per pulse train. For example, the pulse energy for forming a dimple can be 20 μJ, so that about 500 dimples can be created per pulse train. With a typical repetition frequency of 30 kHz, this corresponds to an average power of 300 W.

However, it is also possible for a single pulse to have an energy of 1 mJ and for the single pulse to be split by the beam shaping device into 50 partial laser beams, with each partial laser beam having an energy of 20 μJ. Each partial laser beam can then be transferred to a single laser focus on the surface of the material, so that each partial laser beam of the single pulse creates a dimple.

In particular, it is possible that the multi-focus distribution has an intensity gradient, in particular that the individual foci of the multi-focus distribution have different intensities at least in parts.

In particular, different laser foci can have different laser energies. Since the laser energy determines the size of the dimple through the isointensity area, dimples of different sizes can be created by a different distribution of the energies in the laser focus.

The beam shaping device may be an acousto-optic deflector and/or a microlens array and/or a diffractive optical element.

A diffractive optical element is configured to influence the incident laser beam in one or more properties in two spatial dimensions. Typically, a diffractive optical element is a specially designed diffraction grating, wherein the incident laser beam is brought into the desired beam shape by diffraction.

In an acousto-optical deflector, an alternating voltage is applied to a piezo-crystal in an optically adjacent material in order to produce an acoustic wave that periodically modulates the refractive index of the material. The wave can propagate through the optical material, for example as a propagating wave or as a wave packet, or be in the form of a standing wave. By periodically modulating the refractive index, a diffraction grating is realized for an incident laser beam. An incident laser beam is diffracted at the diffraction grating and thus at least partially deflected at an angle to its original beam propagation direction. The grating constant of the diffraction grating and thus the deflection angle depends, among other things, on the wavelength of the acoustic wave and thus on the frequency of the applied alternating voltage. By way of example, deflections in the x- and y-direction can thus be produced by way of a combination of two acousto-optic deflectors in a deflector unit.

The acousto-optical deflector can in particular be a polarization-dependent acousto-optical deflector and can therefore be particularly suitable for high performance. For example, the acousto-optical deflector unit can be a quartz-based deflector unit.

Microlens arrays comprise arrangements of a plurality of microlenses. In this case, microlenses are small lenses, in particular lenses with the typical distance (“pitch”) from lens center to lens center of 0.1 to 10 mm, preferably 1 mm, with each individual lens of the arrangement being able to have the effect of a normal, macroscopic lens. The multiple microlens arrays are used to produce an angular spectrum from the (at least substantially) collimated input laser beam, whereby, depending on the distance between the microlens arrays, a large number of partial laser beams are produced by interference and diffraction effects. The variable change in the interference pattern results in a variation in the number of partial laser beams.

Preferred exemplary embodiments are described below with reference to the figures. In this case, elements that are the same, similar or have the same effect are provided with identical reference signs in the different figures, and a repeated description of these elements is omitted in some instances, in order to avoid redundancies.

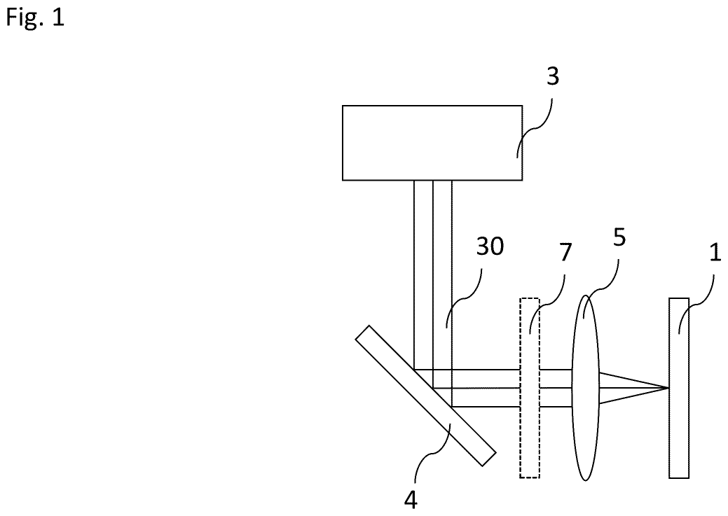

FIG. 1 schematically shows a device according to embodiments of the invention for producing dimples 2. The device has a laser 3 which produces laser pulses 300 that propagate along the laser beam 30 and are focused onto the surface of the transparent material 1 by a processing optics 5.

The laser pulses 300 can then produce dimples 2 and LIPSS on the surface of the transparent material.

The feed device 4 can move the transparent material 1 and the laser beam 30 relative to one another such that the laser beam 30 is moved along the feed trajectory with a feed. For example, the feed device 4 here is designed as a scanner device with which the laser beam 30 is periodically moved over the material 1.

For example, during the advance of the feed device 4, the laser pulses 300 of the laser 3 can be triggered by a random generator so that a random distribution of the dimples 2 is created on the surface of the transparent material 1 (not shown). However, it is also possible that the feed device 4 uses a random generator to spontaneously reposition the laser beam 30, resulting in a random distribution of the dimples 2 on the surface of the transparent material 1 (not shown). In particular, both the feed device 4 and the pulse triggering of the laser 3 can be triggered by such a random generator, so that the distribution of the dimples 2 on the surface of the transparent material 1 is as random as possible (not shown).

In general, the laser pulses 300 of the laser 3 can also be triggered regularly during the feed of the feed device 4.

In addition, a beam shaping device 7 can also be arranged in the beam path, which can impose a multi-focus distribution 70 on the laser beam 30 so that a large number of individual foci are created on the surface of the transparent material 1 by the processing optics.

In order to produce dimples 2, the average emitted laser power at the laser output can be between 30 W and 1000 W, preferably between 30 W and 300 W, so that as many dimples 2 as possible can be produced with the laser beam per second. In addition, the laser pulse duration can be between 300 fs and 10 ps or between 100 ps and 100 ns.

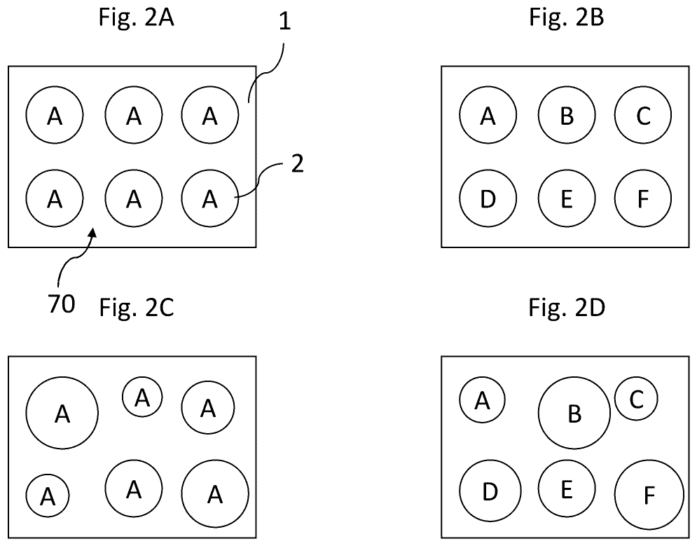

In particular, at these average laser powers, multiple dimples 2 can be produced by means of a single laser pulse 300 or a single laser burst, as shown in FIG. 2.

For example, FIG. 2A shows that a single laser pulse 300 can be shaped into a multi-focus distribution 70 by a beam shaping device 7. Then 300 different dimples 2 can be produced from a single laser pulse. However, it is also possible that all laser pulses 300, here labeled A, B, . . . , F, of a laser burst are directed into all individual foci. However, it is also possible that the beam shaping device 7 performs a rapid repositioning of the laser beam 30 so that one or more laser pulses 300 of the laser burst are arranged at different locations on the surface of the transparent material 1, as shown in FIG. 2B.

However, the multi-focus distribution 70 can also have an intensity gradient, as shown in FIG. 2C. Each individual focus has a different intensity, so that the introduced dimples 2 have a different size. In addition, a random arrangement of the dimples 2 can also be achieved by the multi-focus distribution 70.

However, it is also possible that the successively repositioned laser pulses 300 of the laser burst have a different intensity, as shown in FIG. 2D. Here, too, the dimples 2 then have a different size.

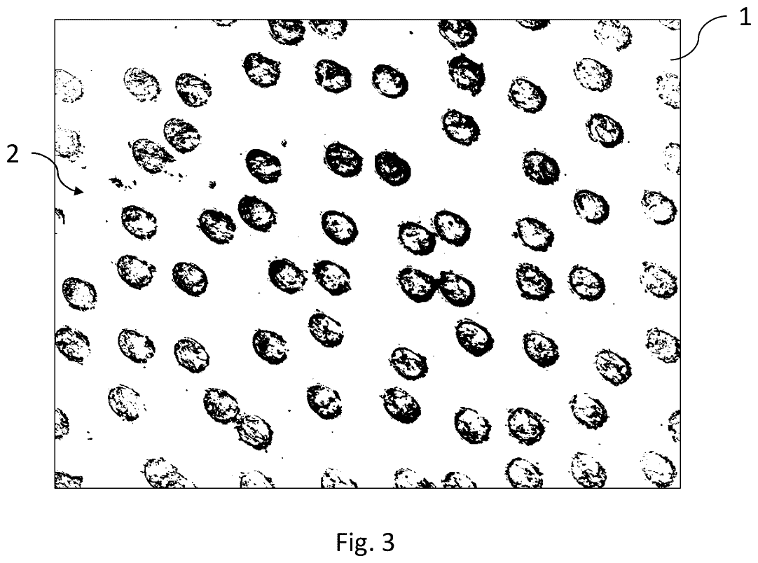

FIG. 3 shows a microscope image of a transparent material 1 with a surface covered by dimples 2. So-called dimples 2 were imprinted on the surface of the transparent material 1 by corresponding laser pulses 300 of a laser 3, for example by two laser pulses 300 of a laser burst. The dimples 2 appear as round to oval ablated defects in the surface of the transparent material 1. In particular, each dimple 2 can be produced individually by two laser pulses of a laser burst.

The transparent material 1 can be, for example, sapphire or quartz glass.

As can be seen in FIG. 3, the dimples 2 can be randomly arranged on the surface of the transparent material, wherein the dimples 2 can also partially overlap or be adjacent to one another. By applying the dimples 2 in an irregular pattern to the surface of the transparent material 1, the direct reflection of an incident light beam in particular can be suppressed, since the incident light beam is refracted by the dimples 2 into a plurality of partial beams and reflected away.

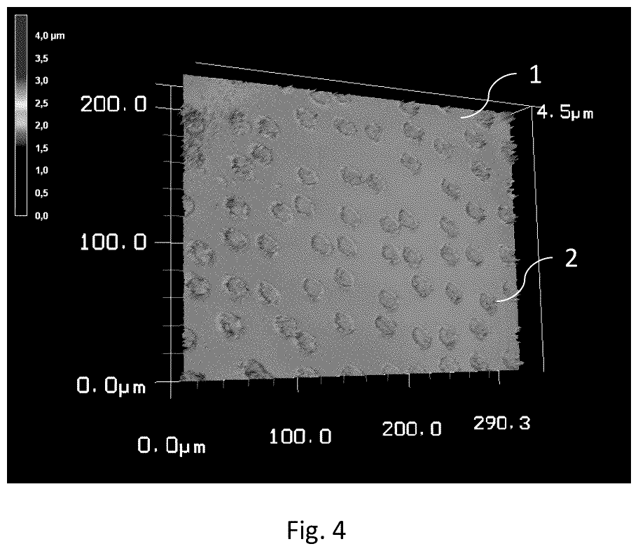

The same transparent material 1 is shown in the dimensioned confocal microscope image of FIG. 4. The dimples 2 have a depth between 100 nm and 2000 nm, for example 500nm. The dimples 2 also have a diameter between 3 μm and 25 μm, for example 20 um. The dimples 2 also have a size variation of between 5% and 80% of the diameter, for example 10%. In addition, the area filling of the surface with the dimples 2 is between 20% and 95%, for example 30%.

For example, the transparent material 1 can be arranged on the display panel of a smart device so that the transparent material 1 functions as a protective or covering layer. In particular, the haptic quality can also be adjusted by the dimple size due to the roughness of the transparent material 1. In addition, the random arrangement of the dimples 2 and/or a dimple size that is smaller than the pixel size can prevent the formation of a moiré effect (not shown).

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Transparent material
2 Dimple
3 Laser
30 Laser beam
300 Laser pulses
4 Feed device
5 Processing optics
7 Beam shaping device

1. A method for producing dimples on a surface of a transparent material using laser pulses of a short-pulse laser, the method comprising:
producing at least one dimple by using a single laser pulse or a single laser burst.

2. The method according to claim 1, wherein a laser pulse duration is between 300 fs and 10 ps or between 100 ps and 100 ns.

3. The method according to claim 1, wherein a laser pulse duration is between 100 ps and 100 ns.

4. The method according to claim 1, wherein the at least one dimple is produced by using the single laser burst, wherein the single laser burst comprises between 2 and 10 laser pulses, and a time interval between the laser pulses is between 10 ns and 50 ns.

5. The method according to claim 1, wherein the at least one dimple is produced by using the single laser burst, wherein the single laser burst comprises between 30 and 300 laser pulses, and a time interval between the laser pulses is between 100 ps and 1000 ps.

6. The method according to claim 1, wherein at least two laser pulses of the single laser burst spatially overlap, wherein laser-induced periodic surface structures are produced.

7. The method according to claim 1, wherein a degree of polarization of the short-pulse laser is more than 80%, preferably more than 95%.

8. The method according to claim 1, wherein a degree of polarization of the short-pulse laser is more than 95%.

9. The method according to claim 1, wherein an average emitted laser power at a laser output is between 30 W and 1000 W.

10. The method according to claim 1, wherein a photon energy of the laser pulses or the laser bursts is smaller than a band gap of the transparent material.

11. The method according to claim 1, wherein a laser beam and the transparent material are capable of being displaced relative to one another using a feed device.

12. The method according to claim 1, further comprising focusing a laser beam onto the surface of the transparent material by using a processing optics.

13. The method according to claim 1, wherein the dimples are randomly positioned on the surface of the transparent material.

14. The method according to claim 1, further comprising shaping a laser beam into a multi-focus distribution by using a beam shaping device, and exposing the surface to the multi-focus distribution, thereby producing several dimples by the single laser pulse or the single laser burst.

15. The method according to claim 14, wherein the multi-focus distribution has an intensity gradient.

16. The method according to claim 15, wherein individual foci of the multi-focus distribution have at least partially different intensities.

17. The method according to claim 14, wherein the beam shaping device comprises an acousto-optical deflector, and/or a microlens array, and/or a diffractive optical element.
